(19) United States
(12) Patent Application Publication
(10) Pub. No.: US 2002/0069107 A1
(43) Pub. Date: Jun. 6, 2002

(54) Video presentation scheduling and control method and system

(76) Inventor: William B. Werner, Plano, TX (US)

Correspondence Address: TEXAS INSTRUMENTS INCORPORATED, P O BOX 655474, M/S 3999, DALLAS, TX, 75265

(21) Appl. No.: 09/731,415

(22) Filed: Dec. 6, 2000

Related U.S. Application Data
(60) Provisional application No. 60/171,709, filed on Dec. 22, 1999.

(51) Int. Cl. G06F 17/60

(52) U.S. Cl. 705/14

(57) ABSTRACT

A system for scheduling and controlling presentation of data (10) includes a data library (40) operable to store a plurality of features (44) and promotional data (42). The system (10) also includes a plurality of data presentation units (30a-30n) each operable to present at least one of the plurality of features (44), where at least one of the plurality of data presentation units (30a-30n) is coupled to the data library (40). The system (10) also includes a server (60) coupled to the data library (40) and operable to select at least one of the desired number of features (44) to present at a selected one of a desired plurality of times. The server (60) is also operable to determine restrictions applicable to the selected feature (44) and select applicable promotional data (42) to be presented with the selected feature (44). The server (60) is also operable to select a location in which to present the selected feature (44). The server (60) is also operable to automatically provide the selected feature (44) and promotional data (42) from the data library (40) to at least one of the plurality of data presentation units (30a-30n) in the selected location at approximately the selected one of the desired plurality of times. In addition, the scheduling and control process may also be further operable to control at least one facility element (32a-32m) within the selected location at the selected one of the desired plurality of times.

### BACKGROUND OF THE INVENTION

Forums such as movie theaters, department stores, museums and the like typically present video data such as film features, music videos, advertisements or slide shows at various times each day, in various auditoriums or rooms. Scheduling presentations for each auditorium presents a challenge for owners and/or operators. For example, a main film feature presented in a movie theater may be subject to restrictions, such as studio restrictions, that may contractually require the feature to be shown with certain equipment or for a given time period. Moreover, unexpected breakdowns in equipment, such as projectors or televisions, may prevent a certain feature from being presented at a scheduled time. These restrictions and limitations often reduce the flexibility and/or planning that a theater operator or owner may provide, and thus may reduce revenue. These problems are amplified as the number of auditoriums and features grows.

In addition, virtually all of these movie theaters use cellulose triacetate based films for the main feature and for movie trailers and/or advertising spots, which are generally presented before the main feature is shown. Each main feature is typically shipped to a theater in one or more 20-minute reels, which must generally be spliced together and placed onto a large platter once at the theater. The theater owner must also manually splice each trailer and/or advertising spot to the reel at the front of the feature. Such splicing is labor-intensive and reduces the flexibility with which various advertising spots and/or trailers may be presented with the feature.

These trailers and/or advertising spots may also often be different for each screen and/or movie within a theater. It is typically desirable to change the order and/or the content of the trailers over the life of the featured movie in any given theater, and these reels must be manually spliced each time the change is required. Problems with these logistics for ordering and scheduling presentation of the features with such a variety of trailers compound when a central office orders data for a number of theaters or multiplexes.

### SUMMARY OF THE INVENTION

From the foregoing, it may be appreciated that a need has arisen for providing a video presentation scheduling and control method and system. In accordance with the present invention, a system and method are provided that substantially eliminate or reduce disadvantages and problems of conventional systems.

According to an embodiment of the present invention, there is provided a system for scheduling and controlling presentation of data includes a data library operable to store a plurality of features and promotional data. The system also includes a plurality of data presentation units each operable to present at least one of the plurality of features, where at least one of the plurality of data presentation units is coupled to the data library. The system also includes a server coupled to the data library and operable to select at least one of the desired number of features to present at a selected one of a desired plurality of times. The server is also operable to determine restrictions applicable to the selected feature and select applicable promotional data to be presented with the selected feature. The server is also operable to select a location in which to present the selected feature. The server is also operable to automatically provide the selected feature and promotional data from the data library to at least one of the plurality of data presentation units in the selected location at approximately the selected one of the desired plurality of times. In addition, the scheduling and control process may also be further operable to control at least one facility element within the selected location at the selected one of the desired plurality of times.

The invention provides several important technical advantages over conventional systems. Various embodiments of the invention may have none, some, or all of these advantages. One technical advantage improves the efficiency for scheduling and ordering of various trailers and/or advertising spots to be shown for a selected feature. Another technical advantage is that ordering of presentation and/or promotional data may then be quickly and easily modified as needed. Such flexibility may provide the ability to schedule data presentation in advance. Another technical advantage provides accounting information such as ticket sales or promotional materials that may have been shown in a selected auditorium and/or with a selected feature. Another technical advantage is that presentation and promotional data may be routed to one or more projectors within an auditorium from a centralized distribution point. Another technical advantage is an interface for authorization of encrypted data. These advantages may also allow centralization and/or integration of data management and/or authorization with accounting functions.

Another technical advantage may improve flexibility for receiving, accessing, and utilizing promotional material. For example, the invention may eliminate the need for laborious splicing of films, and increase the flexibility for various trailers and/or advertising spots to be used with any feature. Another technical advantage may provide for download or wireless access of advertisements and other promotional material and features. Another technical advantage may also provide centralized monitoring of diagnostic information or status for data presentation units and/or facility elements, and/or scheduling responsive to such maintenance or facility information. Another technical advantage may also provide monitoring and control of environmental operations in auditoriums within a theater. Other technical advantages may be readily ascertainable by those skilled in the art from the following figures, description, and claims.

### BRIEF DESCRIPTION OF THE DRAWINGS

For a more complete understanding of the present invention and the advantages thereof, reference is now made to the following description taken in connection with the accompanying drawings, wherein like reference numerals represent like parts, in which:

FIG. 1 illustrates a block diagram of one embodiment of a scheduling and control system;

FIG. 2 illustrates in more detail an example of process modules that may be used in the scheduling and control system;

FIG. 3 illustrates an example of a method for scheduling presentation of data.

### DETAILED DESCRIPTION OF THE INVENTION

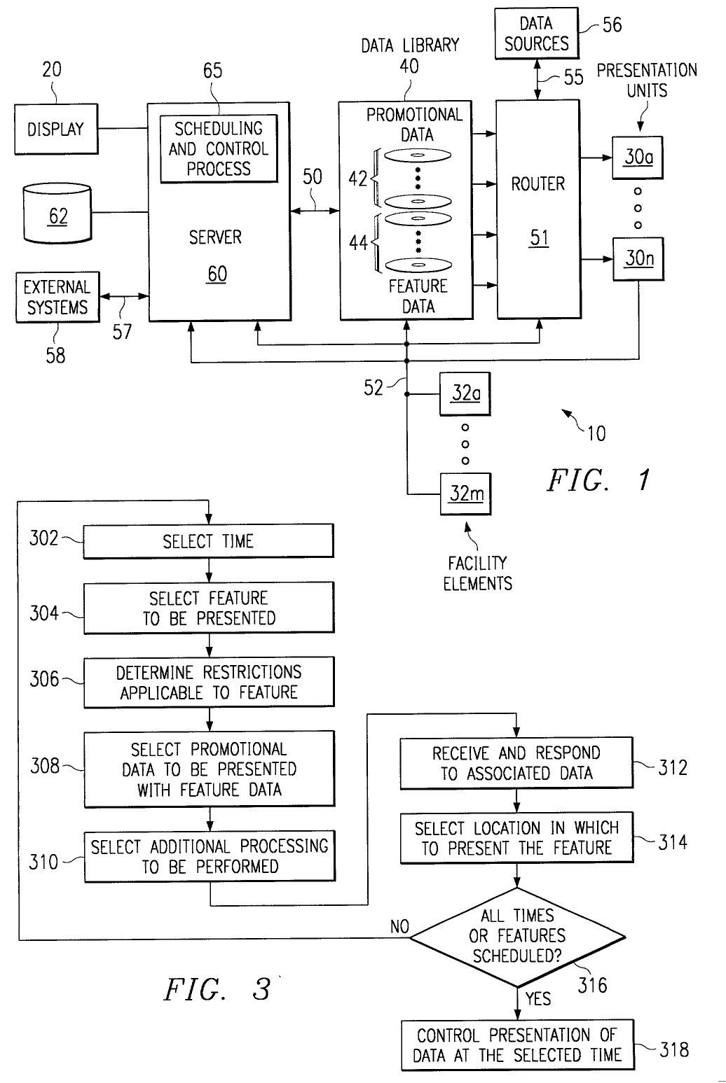

FIG. 1 illustrates a block diagram of one embodiment of a scheduling and control system 10 that includes one or more scheduling managers or servers 60 that manage presentation of data by a plurality of data presentation units 30a-30n. System 10 is operable to communicate with one or many remotely located data sources 56 over one or more communication links 55, and one or more remotely located external systems 58 via communication link 57. Communication links 55 and 57 may be any suitable communication link that can meet throughput and other requirements as needed to transfer data to system 10. For example, communication links 55 and 57 may be a local area network (LAN), a wide area network (WAN), a public or private network, a global data network such as the Internet, an antenna, a telephone line, or any fiber optic, wireline or wireless link such as a satellite link. Communication links 55 and 57 may also be a Digital Subscriber Line (DSL), or any variety thereof.

Generally, system 10 provides a number of services to monitor, schedule, and/or control presentations of data using one or more data presentation units 30a-30n. In a particular embodiment, system 10 accomplishes these tasks by maintaining accurate information associated with, and/or controlling, a variety of facility elements 32a-32m. It is contemplated that system 10 may be maintained, used, and/or operated by any one or a combination of data providers such as studios, service providers such as theater owners or operators, or any other entity or organization seeking to present video data using one or more data presentation units.

System 10 may utilize any suitable network protocol and logical or functional configuration that provides for the passage of a variety of data to and from server 60, including wireless technologies. For example, server 60 communicates with data library 40 and optionally router 51 using network 50, which may be a LAN, a WAN, a public or private network, a global data network such as the Internet, a fiber optic, wireline or wireless network, or any other suitable communication network that can meet throughput and other system requirements as needed. For example, network 50 may be used to transfer to data library 40 compressed data, uncompressed data, or a combination thereof. In a particular embodiment, network 50 may be a 100baseT Ethernet that communicates message and data traffic using a suitable messaging protocol. In some applications, server 60 may also couple to router 51, one or more data presentation units 30a-30n, and/or one or more facility elements 32a-32m using network 50. Alternatively or in addition, server 60 may use one or more communication links 52 such as a control or status bus suitable to communicate diagnostics or control data to and/or from router 51, one or more data presentation units 30a-30n, and/or one or more facility elements 32a-32m. In some applications, server 60 may collect diagnostics and/or status information from one or more data presentation units 30a-30n a dedicated diagnostics backchannel.

System 10 may optionally include a router 51 between data library 40 and data presentation units 30a-30n to meet throughput and other system requirements as needed. Router 51 may be any suitable server, computer, switch, or portions therein, or any other suitable processing device operable to, for example, examine destination addresses for data and route data to a selected data presentation unit based on these addresses. Router 51 may also be programmed to forward data through different paths based on line availability, utilization, or other parameters, or to construct a secondary traffic path in the event a primary path becomes inoperative, on a dynamic or predetermined basis. For example, system 10 may include a serial digital interface (SDI) or serial digital transport interface (SDTI) router 51 to transfer compressed data to one or more data presentation units 30a-30n. Alternatively, a high definition serial digital interface (HD-SDI) router 51 may be used where uncompressed data is transferred to one or more data presentation units 30a-30n. In some applications, data library 40 may also directly transfer data to one or more data presentation units 30a-30n.

Server 60 may be used to execute applications that include communication and scheduling and/or control software. Server 60 may be a workstation, desktop computer, or other general purpose computer and may be adapted to execute any of the well known MS-DOS, PC-DOS, OS2, UNIX, MAC-OS and Windows operating systems or other operating system. Server 60 is illustrated in FIG. 1 coupled to storage medium 62, display 20, network 50 and communications links 52, 55, and 57. Server 60 may also couple to devices such as a mouse, keyboard, printer, and a variety of types of storage media such as, for example, floppy disk drives, hard disk drives, CD-ROM drives, or magnetic tape drives. The present invention includes methods that may be stored in storage medium 62 or other read-only memory (ROM), random access memory (RAM), or disk drives and may be executed by server 60. FIG. 1 only provides one example of a computer that may be used with the invention. The invention could be used with computers other than servers as well as servers without conventional operating systems. In addition, scheduling and/or control may also be performed using special purpose digital circuitry contained either in server 60 or in a separate device. Such dedicated digital circuitry may include, for example, state machines, fuzzy logic, etc.

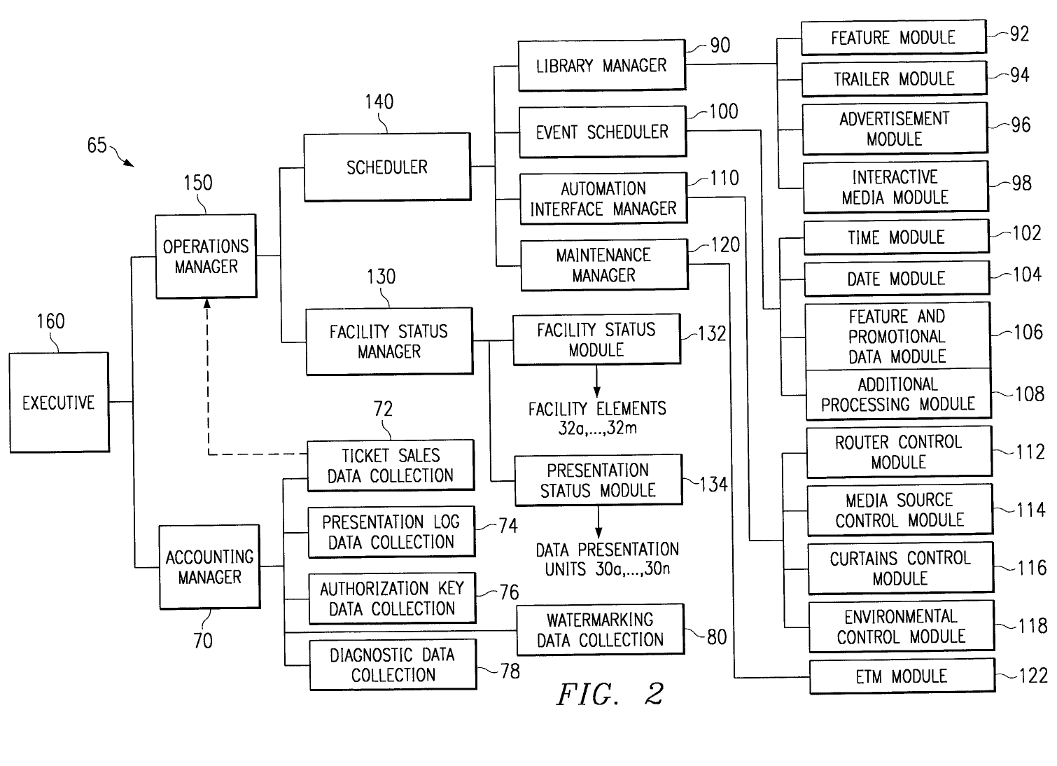

In this embodiment, scheduling and/or control may be performed by software stored and executed by server 60 with the results stored in a storage medium comprising a part of server 60 and/or in storage devices that may be coupled to server 60, such as storage medium 62. For example, server 60 may arrange information, referred to generally as associated data and scheduling data, in storage medium 62, which may be a database or other suitable storage facility, as variables, tables, files, or any other suitable arrangement. In one embodiment, storage medium 62 may support Standard Query Language (SQL), object-oriented operation, or any other suitable storage and retrieval scheme. Server 60 may also maintain at least portions of presentation data and/or promotional data in storage medium 62 or in a memory such as RAM. Associated data and scheduling data information as used in this description refers to any information maintained in storage medium 62 either persistently or for a short period of time, and are further discussed in conjunction with FIGS. 2 and 3.

In operation, system 10 may schedule presentation of feature data 44 and/or promotional data 42 at one or more selected locations on one or more data presentation units 30a-30n for one or more service providers. In some applications, system 10 is also operable to automatically control presentation of data at the selected location using one or more data presentation units 30a-30n, and/or having one or more facility elements 32a-32m.

Feature data 44 and/or promotional data 42 may be stored in data library 40 using any magnetic or optical media such as CD-ROM or Digital Video Disc-ROM (DVD-ROM), tape, digital audio tape (DAT), ROM, RAM, or any other readable media. For example, in one embodiment of the invention, feature data 44 and/or promotional data 42 may be film that may be presented using standard projectors.

Alternatively or in addition, feature data 44 and/or promotional data 42 may be digital data that may be encrypted, compressed, and/or stored using a variety of formats. For example, feature data 44 may be encrypted using triple data encryption standard (3-DES). Feature data 44 and/or promotional data 42 may also be transferred over network 50 from server 60, to a storage medium within data library 40. For example, other feature data 44 and/or promotional data 42 may be transmitted over communication link 55 from one or more data sources 56. Alternatively or in addition, feature data 44 and/or promotional data 42 may be transmitted over communication link 57 from one or more external systems 58 to server 60. Such data may also be cached in a memory coupled to or co-located with data library 40, router 51, data presentation units 30a-30n (not explicitly shown), or a combination thereof.

Such caching may permit near-simultaneous presentation of the data. Promotional data 42 include additional presentation material that may be selectively shown with one or more feature data 44. For example, promotional data 42 may include promotional materials such as advertisements or movie trailers that may be presented with a feature film. Promotional data 42 may also include still images such as 35 mm slides, interactive data, or other suitable material that may be selectively presented with one or more feature presentations according to the needs of a service provider and/or other requirements.

Feature data 44, or features 44, may include any data that may be presented and/or viewed using data presentation units 30. For example, features 44 may include video or television data, and/or feature films or motion pictures, that are typically distributed by studios for presentation by service providers such as movie theaters, multiplex owners, and the like. As another example, features 44 may also include animated, textual, photographic, or interactively-driven data. Features 44 may reside on tangible media as discussed above and/or be distributed to system 10.

System 10 may also provide additional processing of features 44 that includes a plurality of controlled versions. For example, electronic or digital data may include content stored in a format suitable for selective presentation for a variety of audiences by ratings promulgated in part by the Motion Picture Association of America. In other words, features 44 may include portions of data that would be rated X, R, and NC-17 in some countries. System 10 may be operable to present selected portions of the data to satisfy these movie ratings. Alternatively or in addition, features 44 may include other data such as various audio tracks associated with video data. System 10 may desirably process applicable language tracks for selected service provider requirements. For example, English processing may be selected for primarily English-speaking areas and Spanish processing may be selected for primarily Spanish-speaking locations. Other additional processing is within the scope of the invention and includes, but is not limited to, close captioned or other special needs processing.

Data library 40 may include a variety of types of storage media, such as, for example, hard disk drives, CD-ROM drives, and/or magnetic tape drives. Data library 40 may also be a mass storage device such as a Redundant Array of Independent Disks (RAID), which provides parallel and/or high speed data access. Data library 40 may also provide additional functionality within logic (not explicitly shown). For example, data library 40 may provide data processing functionality such as decryption and decompression, or may couple to such logic that may be coupled to or co-located with one or more data presentation units 30a-30n, and/or router 51. Data library 40 may also maintain in local storage and/or transfer to server 60 information related to presentation and/or promotional data, such as authorization keys that typically provide information suitable to decrypting encrypted data.

Data library 40 may also provide redundancy functionality, in the event of failure, and/or watermarking functionality. Watermarking functionality may allow additional associated information to be captured and to provide, for example, security, management and accounting, and/or legal processing within system 10. For example, data library 40 may include logic suitable to capture a projector number, serial number, theater identifier, and the time of day that one or more features 44 and/or promotional data 42 were presented. This information may be, for example, imbedded within optical media, and used to monitor data and/or projector usage, which may be used to fulfill reporting or contractual requirements, or to provide additional management and/or accounting statistics. The information may also be useful to agencies seeking to prevent or enforce counterfeiting and/or piracy laws of various jurisdictions.

Each data presentation unit 30a-30n is associated with a location, such as a theater, department store section, home office, auditorium, etc., in which video data may be presented. More than one location may be included at one service provider, as may be the case for a multiple auditorium theater complex. Each location may also be remotely located from server 60, as may be the case where an entity performs scheduling for one or more service providers such as theater owners. A data presentation unit may be a video display device such as an electronic screen or video monitor such as a television or computer monitor. A data presentation unit may also be a standard electronic projector that uses a cathode ray tube (CRT) to modulate light values or an electronic projector such as a digital micro-mirror device (DMD). The plurality of data presentation units 30a-30n may also be different devices and one or more data presentation units may be associated with the same location.

One or more data presentation units 30a-30n may also each be a processing unit operable to perform one or more image and/or data processing functions, such as decompression, and/or decryption. Alternatively or in addition, one or more data presentation units 30a-30n may each include variable optics configurations that may be manually or automatically controlled. For example, one configuration may include a rotatable lens that may provide various aspect ratios for presenting data such as feature films. One such lens may be operable to provide both a CINEMASCOPE™ display, which typically uses a 2.39:1 aspect ratio, and a flat display, which is typically a 1.85:1 aspect ratio.

Server 60 may also allow service providers to monitor and manage one or more facility elements 32a-32m and/or one or more data presentation units 30a-30n.

Facility elements may include, but are not limited to, environmental units within a location, such as air conditioning or heating units, and lighting. Facility elements may also include other elements such as door locks, sound system devices, and/or curtains that may be opened and closed in front of a presentation screen. For example, one or more facility elements 32a-32m and/or one or more data presentation units 30a-30n may be automatically controlled, and may each include an output such as an RS422 serial communications port or ethernet port to output diagnostics or other status data that may be utilized by server 60. Facility elements 32a-32m may issue messages, notifications, or otherwise indicate a status change for a variety of reasons such as maintenance requirements or complete or partial failure. Traditionally, if there is a loss of operational capability or a desired maintenance schedule, slow and cumbersome methods for rescheduling presentation of data using these elements cause undesirable problems, especially with significant traffic demands on a bandwidth-limited network 50. This problem may be further exacerbated by scheduled downloads of features from data sources 56. Therefore, in one important aspect of the present invention, server 60 may take into account this facility data in performing scheduling and/or control functions.

For example, in some applications, server 60 may receive status data for one or more facility elements 32a-32m and/or one or more data presentation units 30a-30n and display to a user a current view or status, such as a graphical user interface (GUI), therefor. The user may then perform scheduling and/or presentation of data in response to the status data. In a particular embodiment, server 60 may operate or interface with an application programming interface (API), such as CORBA, or other suitable external program to deliver scheduling and control functions to the one or more facility elements 32a-32m and/or one or more data presentation units 30a-30n. In other applications, system 10 may automatically perform scheduling and/or presentation of data in response to the status data.

FIG. 2 illustrates in more detail an example of process modules that may be used in a data presentation scheduler and controller process 65 of a scheduling and control system 10. In a particular embodiment, data presentation scheduler and/or controller process 65 resides on server 60, which may be a Unix workstation and the modules may represent separate processes spawned by the workstation to provide a variety of functions. In some embodiments of the invention, system 10 may schedule presentation of video data, and in others, system 10 may control video presentation. The illustrated embodiment shows one example for a data presentation scheduler and controller process 65 providing both scheduling and control functionality by system 10. It should be understood that data presentation scheduler and controller process 65 contemplates any number and arrangement of modules to accomplish the various tasks of scheduling and/or controlling presentation of data within system 10. For example, portions of the tasks performed by executive 160, operations manager 150 and/or optionally accounting manager 70 may be combined or rearranged generally into a processor having related hardware and/or software components.

The scheduling and control system software includes an executive 160, which may be used to transfer and receive data to other processes within server 60, or to other systems 58. Executive 160 is also operable to manage and control an operations manager 150 and/or optionally an accounting manager 70 and data transfer therebetween, and may also be operable to perform desirable administrative functions.

Accounting manager 70 may optionally be used as needed to monitor, record, process and/or transfer accounting data that may be useful to maintain administrative and/or accounting statistics. Accounting data may include, but is not limited to, information that may be used to schedule and/or control presentation of data for a service provider, or for other administrative purposes. For example, accounting manager 70 may collect and/or utilize data with data collection modules that include, but are not limited to, ticket sales 72, presentation log 74, authorization keys 76, diagnostic 78, and watermarking 80. Ticket sales data collection module 72 may collect, for example, data related to the quantities and types of tickets purchased for a given time period, location, or other criteria. Presentation log data collection module 74 may provide information related to monitoring presentation of features, and/or usage of locations and/or data presentation units 30a-30n. For example, the information may include the seating capacity, the type of screen and/or the type of sound system used within an auditorium. Such information may be desirably processed and/or stored for reporting compliance with restrictions such as studio restrictions that apply to certain features 44. Accounting manager 78 may also monitor information related to watermarking functionality as previously discussed, by using watermarking data collection module 80.

Accounting manager 70 may also collect diagnostic data related to one or more data presentation units 30a-30n using diagnostic data collection module 78, which may communicate with the data presentation units over communication link 52 or a dedicated diagnostics backchannel. Accounting manager 70 may also collect authorization key data associated with encrypted data that has been encrypted, as previously discussed, using authorization key data collection module 76. Accounting manager 70 may also maintain data and/or transfer data to and/or from an external system 56, whether or not modified. For example, system 10 may report such data to an independent clearinghouse to comply with requirements for reporting accounting data to service and source providers. Accounting manager 70 may also suitably process and/or transfer such data to operations manager 150, to be used for scheduling and/or control of video presentations. Accounting manager 70 may also provide functionality in response to scheduling and/or control needs. For example, accounting manager 70 may authenticate or verify authorization key data, and/or order additional authorization key data needed to present decrypted data according to schedule. Each data collection module may be operable to automatically collect electronic information or receive input entered by a user and store the data in a suitable format, for example in RAM on server 60 or in storage medium 62, for use by accounting manager 70. Data may be collected from time to time, at various intervals, or as needed.

Operations manager 150 may include a scheduler 140 and optionally a facility status manager 130, to provide support for video presentation scheduling and/or control. For example, in some applications, facility status manager 130 may request or poll for and/or maintain facility data, which may include selected diagnostic and/or status data for one or more facility elements 32a-32m and/or one or more data presentation units 30a-30n. For example, facility status manager 130 may use facility status module 132 to poll monitor, record, and/or transfer facility status data that may indicate the operability of such elements. Similarly, facility status manager 130 may use presentation status module 134 to poll monitor, record, and/or transfer data that may indicate status and/or diagnostic information from one or more data presentation units 30a-30n. These data may be used for scheduling purposes to accommodate, for example, equipment failure. These data may include, but are not limited to, environmental data for a location, which may indicate room temperature, lighting, and/or any status or diagnostics information such as projector lamp age from equipment that may affect effective presentation of data in that location. In some applications, these data may be desirably transferred from server 60 to an external system 58 that provides central facility control. Each data collection module may be operable to automatically collect electronic information or receive input entered by a user and store the data in a suitable format, for example in RAM on server 60 or in storage medium 62, for use by facility status manager 130. Data may be collected from time to time, at various intervals, or as needed.

Scheduler 140 may coordinate scheduling and/or control data presentation for system 10. Scheduler 140 may include library manager 90, event scheduler 100, automation interface 110, and/or maintenance manager 120, and coordinate the operations thereof For example, scheduler 140 may coordinate inventory information and data ordering to ensure that data such as authorization key data are timely ordered, received, and/or operable by system 10 to present data according to a desired schedule. Library manager 90 may monitor a current inventory of promotional data 42 and features 44 in data library 40 using a variety of suitable methods. For example, library manager 90 may automatically communicate with data library 40 to collect electronic information, or receive inputs entered by a user, and store the data in a suitable format, for example in RAM on server 60 or in storage medium 62, for use by scheduler 140. In some applications, library manager 90 may perform such functions automatically, from time to time, or as data is received. Library manager 90 may include, but is not limited to, one or more monitor modules 92, 94, 96, and 98. For example, feature module 92, trailer module 94, advertisement module 96, and interactive media module 98 may each individually monitor respective promotional data 42 and features 44. Library manager 90 or scheduler 140 may then send requests to service providers, studios, contractors or other entities for any data needed.

Similarly, maintenance manager 120 may monitor maintenance data such as an estimated time to maintenance for one or more data presentation units 30a-30n using an ETM module 122. ETM module 122 may communicate with one or more data presentation units 30a-30n using communication link 52 and/or a separate diagnostics backchannel. Maintenance manager 120 may perform such functions automatically where, for example, one or more data presentation units 30a-30n are operable to output status data. In other applications, such data may be provided with an elapsed time meter, or entered into a database and monitored therefrom. Scheduler 140 may also communicate data from accounting manager 70, library manager 90, and/or maintenance manager 120 to event scheduler 100 and/or automation interface manager 110 as needed.

Event scheduler 100 may provide, modify, and/or optimize a schedule for presentation of data using data presentation units 30a-30n, and is discussed in further detail in conjunction with FIG. 3. To provide, modify, and/or optimize the schedule, event scheduler 100 may utilize information provided by other processes such as library manager 90 and maintenance manager 120. In this embodiment, event scheduler 100 may include one or more modules to create and/or modify scheduling data. For example, event scheduler 100 may individually process or select parameters using a time module 102, date module 104, and feature and promotional data module 106. Event scheduler 100 may also optionally create and/or modify scheduling data by using additional processing module 108 to provide additional data processing of, for example, feature versions and/or decryption.

In some applications where one or more data presentation units 30a-30n and/or one or more facility elements 32a-32m may be automatically monitored and/or controlled, automation interface manager 110 may provide centralized control thereof. For example, automation interface manager 110 may monitor, record, process and/or transfer data associated with environmental conditions within service provider's forums. Additionally, automation interface manager 110 may utilize information provided by other processes such as event scheduler 100, and automatically control data presentation in response to such information. For example, automation interface manager 110 may, in response to scheduled data from event scheduler 100, send control data through control modules that may include, but are not limited to, control modules 112, 114, 116, and 118 to begin a coordinated presentation of data at a scheduled location. Control modules 112, 114, 116, and 118 may provide input and output control functionality to devices such as router 51 and/or any facility elements 32a-32m that may be electronically controlled. For example, router control module 112 may be operable to communicate with and provide addressing functionality to router 51 and/or data library 40 so that data is transferred to a particular data presentation unit. As another example, environmental control module 118 may provide control functionality to lights via a contact closure relay mechanism.

To illustrate, automation interface manager 110 may, at or just prior to a scheduled time, automatically increase air conditioner flow to a scheduled location through environmental control module 118. A data presentation unit 30a-30n may be initialized and/or warmed up through media control module 114 at a similar time. Shortly thereafter or at a second scheduled time, automation interface manager 110 may automatically dim lights through environmental control module 118 and open curtains through curtain control module 116 within the location. Shortly thereafter or at a third scheduled time, automation interface manager 110 may transfer data from data library 40 through media control module 114, and optionally through router 51 using a router control module 112 to a selected data presentation unit. The selected data presentation unit may be activated by such a transfer or separately activated through media control module 114. In operation, automation interface manager 110 and facility status manager 130 may coordinate polling and/or monitoring of status data generated by data presentation units 30a-30n and facility elements 32a-32m, so that scheduler 140 may coordinate the scheduling and/or control of data presentation.

FIG. 3 illustrates an example of a method for scheduling presentation of data. The method may be performed by software, such as data presentation scheduler and controller process 65, resident on server 60. In one embodiment, event scheduler 100 may perform substantially all of the steps of the method in conjunction with other modules, as discussed previously. Although steps 302-318 are illustrated as separate steps, various steps may be ordered in other logical or functional configurations, or may be single steps. The method may be invoked periodically (e.g., once a day, once a week) or as needed, by a user or autonomously by server 60. For example, system 10 may perform the method upon receipt of new data or restrictions. Some of the steps of the method may include participation by a user using a variety of known methods. For example, system 10 may display to a user a graphic user interface (GUI), pull-down menus, and/or hyperlinked entries or forms. In such embodiments, the user may select, enter, modify or print data, none, some or all of which may be in response to prompting by system 10.

The method begins at step 302, where a time and/or date for presentation is selected. For example, the time and/or date may be an actual or relative time, duration or window. For example, it may be desirable in some embodiments to schedule presentation of data using a duration of time such as three hours, while in others scheduling by an absolute time, such as 12:05 P.M., may be preferable. Alternatively or in addition, system 10 may utilize a time or time duration that may be relative to a reference, such as three hours after the first time selected. Other variations are also within the scope of the invention and include, but are not limited to, days of the week, holidays, etc. In step 304, the user or system 10 then selects a feature, or features 44, to be presented at the time selected in step 302. Alternatively, system 10 may also first select a feature, and then select a time to present the feature.

In step 306, system 10 determines whether restrictions may be applicable to presentation of the features 44. Such restrictions may be optional or required for system 10 to perform scheduling and/or control, and may include, but are not limited to, service provider restrictions, studio restrictions, and/or other restrictions. For example, a service provider may wish to display various features 44 during times and/or on dates that may maximize its revenues. Features 44 targeted toward business conferences or children may desirably be presented during daylight hours, while adult-oriented data may desirably be presented during evening hours. Distributors such as studios may associate various restrictions in accordance with contractual or other provisions associated with some or all features 44. For example, a selected feature 44 may be presented only in auditoriums that utilize a certain sound or projector system, which may have a minimum or maximum number of seats, etc. Some restrictions may include requiring a service provider to present a feature for a continuous period such as two weeks, or require a certain number of presentations during a period. Other restrictions may include, but are not limited to, age and/or content restrictions that may be associated with the feature, such as an R rating.

In step 308, system 10 may select one or more promotional data 42 such as trailers, advertisements, promotional material, and/or interactive data to be presented with features 44. System 10 may also select a plurality of promotional data 42 that may be presented with features 44 at various times, locations, and/or dates, and with various data presentation units 30a-30n. In some embodiments of the invention, promotional data 42 may be presented with features 44 by direct data transfer from data library 40 to one or more data presentation units 30a-30n rather than by using traditional splicing techniques. Alternatively or in addition, system 10 may select a period of time during which these promotional data 42 may be presented with features 44. Therefore, in one important aspect of the present invention, system 10 provides flexibility to change and/or rotate desirable promotional data 42 to be presented with features 44. System 10 may combine the selected promotional data 42 with the selected feature 44 before the scheduled presentation or on-the-fly as data is transferred to a data presentation unit.

In step 310, system 10 may optionally select additional processing that may be performed. For example, where a feature 44 is electronic data that may include a plurality of controlled versions, it may be desirable to extract a suitable portion of data from feature 44 to present for the selected time and date. Thus, system 10 may select R rated features for later times, such as after 10:00 p.m., while restricting PG features to selected times before 10:00 p.m. System 10 may then extract data suitable for presenting during that selected time. System 10 may also desirably perform other processing, such as extracting and presenting applicable language tracks for a selected time, date, or service provider location. As another example, where feature 44 is encrypted, system 10 may decrypt feature 44 using an associated authorization key, or transfer the authorization key with feature 44 to a data presentation unit for decryption. System 10 may perform such processing before the scheduled presentation or on-the-fly as data is transferred to a data presentation unit.

In step 312, system 10 may optionally receive associated data. As discussed previously, associated data may include, but is not limited to, facility, maintenance, and/or accounting data. For example, where a selected feature is encrypted, system 10 may utilize a proper authorization key to decrypt the data. Alternatively, or in addition, it may also be desirable for system 10 to phase out or discontinue presentation of a featured movie if ticket sales indicate that the movie is not selling well. As another example, a featured movie may be moved to a data presentation unit at a location with a smaller or larger seating capacity based on ticket sales. System 10 may deactivate the feature from future selection, and/or select a replacement feature and proceed through steps 302-318 for the newly selected feature. System 10 may more efficiently utilize resources and/or maximize revenues by adaptively scheduling presentation and promotional data in response to such data.

Similarly, system 10 may deactivate a location and/or a data presentation unit in response to such associated data. For example, system 10 may receive facility data that indicates a mechanical or electrical problem with a certain theater and/or that indicates a particular data presentation unit is undergoing maintenance or needs maintenance service. System 10 may deactivate the theater from being selected in response to facility data where, for example, a data presentation unit, or environmental services such as air conditioning are not operable for that theater. System 10 may also schedule additional operational events such as maintenance or service visits in response to associated data. System 10 may more efficiently utilize resources and/or maximize revenues by adaptively scheduling presentation and promotional data in response to such associated data.

In step 314, system 10 selects a location in which to present the data. System 10 may utilize restrictions and/or other associated data to determine the location. For example, some features 44 may be presented using a display format such as CINEMASCOPE™ or with a particular sound format such as Dolby™ Spectral Recording-Digital (SR-D), Digital Theater Systems (DTS™), Sony Dynamic Digital Sound (SDDS™). Similarly, some features 44 may be contractually required to be presented with certain certified systems such as THX™. System 10 may also determine the location by utilizing other associated data such as presentation compatibility or additional processing that may be required, such as decryption and/or decompression. Similarly, where a selected feature 44 is in electronic form and is compressed data, system 10 may select a location with a data presentation unit having decompression functionality.

In step 316, system 10 returns to step 302 to complete scheduling for some or all remaining features 44 or times that have not yet been scheduled. For example, system 10 may schedule a desired number of features for a desired number of times and then rotate remaining features as desired. Alternatively, system 10 may schedule all remaining features 44 for all of the time slots. In step 318, system 10 may optionally use associated data and scheduling data to control presentation of the selected feature 44 and associated logistics of the selected location as discussed previously in conjunction with automation interface manager 110. For example, at approximately the selected time, system 10 may automatically initiate transfer of promotional data 42 and/or feature 44 to a selected data presentation unit. System 10 may also designate times to control facility elements within the selected location. For example, system 10 may also automatically perform suitable initialization and/or warmup functions for the selected data presentation unit and/or adjust room temperature before the selected time. System 10 may also dim lights and/or control opening of the curtains in the selected theater before the selected time and brighten lights and/or control closing of the curtains after the presentation of data is complete.

System 10 may display scheduling data using display 20 and/or transfer the schedules to external systems 58. System 10 may also store the scheduling data in storage medium 62 or in memory in a suitable format, including any database scheme. For example, a service provider may elect to store scheduling and/or associated data in tables, flat files, or a database, for display, transfer, and/or modification. System 10 may also display the scheduling data to a variety of desired peripherals, including the locations in which data may be presented.

System 10 may also create, modify, and store parameters such as dates and data to be presented for the method as needed. For example, a service provider may choose to automatically monitor associated data such as accounting data, facility data, and maintenance data, and to modify scheduling data in response to the associated data. System 10 may also optionally elect to schedule maintenance and/or servicing between times during which data is presented, and/or for theaters that have been deactivated from selection in response to operational failure.

Thus, it is apparent that there has been provided in accordance with the present invention, a video presentation scheduling and control system that satisfies the advantages set forth above. Although the present invention has been described in detail, various changes, substitutions, and alterations may be readily ascertainable by those skilled in the art and may be made herein without departing from the spirit and scope of the present invention as defined by the following claims.

What is claimed is:

1. A system for scheduling and controlling presentation of data, comprising:
a data library operable to store a plurality of features and promotional data;
a plurality of data presentation units each operable to present at least one of the plurality of features, at least one of the plurality of data presentation units coupled to the data library; and
a server coupled to the data library and operable to
select at least one of a desired number of features to present at a selected one of a desired plurality of times;
determine restrictions applicable to the selected feature;
select applicable promotional data to be presented with the selected feature;
select a location in which to present the selected feature; and
automatically provide the selected feature and promotional data from the data library to at least one of the plurality of data presentation units in the selected location at approximately the selected one of the desired plurality of times.

2. The system of claim 1, wherein the server is further operable to create new scheduling data by rotating the selection of promotional data to be presented with the selected feature.

3. The system of claim 1, wherein the at least one of the data presentation units comprises an electronic projector.

4. The system of claim 1, wherein the server is operable to receive feature and promotional data from a remote source for transfer to the data library.

5. The system of claim 1, wherein the server is further operable to control at least one facility element within the selected location at the selected one of the desired plurality of times.

6. The system of claim 1, wherein promotional data are selected from one of the group consisting of trailers, advertisements, and interactive data.

7. The system of claim 1, wherein the feature is transmitted to the at least one data presentation unit using a wireless communication link.

8. A data presentation scheduler and controller, comprising:
a server coupled to a storage medium; and
a scheduling and control process resident on the server and operable to create scheduling data by repeating for a desired number of features and a desired plurality of times:
selecting at least one of the desired number of features to present at a selected one of the desired plurality of times;
determining restrictions applicable to the selected feature;
selecting applicable promotional data to be presented with the selected feature; and
selecting a location having a data presentation unit in which to present the selected feature; and
storing the scheduling data on the storage medium.

9. The scheduler of claim 8, wherein the server is further operable to automatically initiate transfer the selected feature and promotional data to at least one of the data presentation units in the selected location at approximately the selected one of the desired plurality of times.

10. The scheduler of claim 8, wherein the process is further operable to select the location in response to one of the group consisting of facility data, maintenance data, and accounting data.

11. The scheduler of claim 8, wherein the process is further operable to deactivate the feature to present in response to accounting data.

12. The scheduler of claim 8, wherein promotional data are selected from one of the group consisting of trailers, advertisements, and interactive data.

13. The scheduler of claim 8, wherein the process is further operable to create new scheduling data by rotating the selection of promotional data to be presented with the selected feature.

14. The scheduler of claim 8, wherein the process is further operable to control at least one facility element within the selected location at the selected one of the desired plurality of times.

15. A method for scheduling and controlling presentation of data, comprising:
selecting one of a plurality of features to present at one of a plurality of selected times using a computer;
determining restrictions applicable to the selected feature using the computer;
selecting applicable promotional data to be presented with the selected feature using the computer;
selecting a location with a data presentation unit in which to present the selected feature using the computer; and
repeating the features selecting, restrictions determining, promotional data selecting, and location selecting steps for a desired number of the remaining plurality of features.

16. The method of claim 15, further comprising automatically transferring the selected feature and promotional data to at least one of the data presentation units in the selected location at approximately the selected one of the desired plurality of times.

17. The method of claim 15, further comprising receiving feature and promotional data from a remote source.

18. The method of claim 15, wherein the location is selected in response to one of the group consisting of facility data, maintenance data, and accounting data.

19. The method of claim 15, further comprising deactivating the selected feature in response to ticket sales data.

20. The method of claim 15, further comprising controlling at least one facility element within the selected location at the selected one of the desired plurality of times.
